(19) United States
(12) Patent Application Publication
(10) Pub. No.: US 2022/0058589 A1
(43) Pub. Date: Feb. 24, 2022

(54) METHODS, SYSTEMS AND COMPUTER PROGRAM PRODUCTS FOR MANAGEMENT OF WORK SHIFT HANDOVER REPORTS IN INDUSTRIAL PLANTS

(71) Applicant: Yokogawa Electric Corporation, Tokyo (JP)

(72) Inventors: Jinsong QIAN, Singapore (SG); Khac Trung Nguyen NGUYEN, Singapore (SG)

(73) Assignee: Yokogawa Electric Corporation, Tokyo (JP)

(21) Appl. No.: 16/997,118

(22) Filed: Aug. 19, 2020

(51) Int. Cl. G06Q 10/10; G06F 40/30; G06Q 10/06; G06N 3/04

(52) U.S. Cl. CPC G06Q 10/1091; G06F 40/30; G06N 3/04; G06Q 10/0633; G06Q 10/063114

(57) ABSTRACT

The present invention provides methods, systems and computer program products that enable generating a shift handover report for display. The invention comprises (i) receiving a plurality of operator shift reports, (ii) parsing data from the received operator shift reports, and selecting a set of shift report data from the parsed data, wherein the selection is based at least on output received from a decision engine that is configured to (a) receive one or more of text data, tabular data, image data, audio data or video data, parsed the operator shift reports, and (b) output a score indicating suitability of shift report data corresponding to the input data, for inclusion within a shift handover report, (iii) generating and storing a shift handover report comprising the selected set of shift report data, and (iv) displaying the generated shift handover report comprising the selected set of shift report data.

### FIELD OF THE INVENTION

The invention relates to the field of industrial plant management, and more specifically to methods, systems and computer program products that enable management of work shift handover reports within industrial plants.

### BACKGROUND OF THE INVENTION

Industrial environments implement process control systems for running and controlling processes for manufacturing, conversion, or production. Process control systems typically include one or more process controllers that are connected to one or more field devices. Field devices, may include valves, valve actuators, switches, and transmitters (e.g. temperature, pressure, level, and flow sensors) located within the industrial environment, and which are configured for physical control functions or process control functions. Examples of field device control functions include opening or closing valves, and measuring process and/or environmental parameters (e.g. temperature or pressure) for controlling one or more processes within the process plant or system.

The physical environment of a plant often comprises a large geographically dispersed system (e.g. a large network of fluid pipelines) or a complex multi-step system (e.g. a large refinery system). The physical environment or industrial environment therefore requires operators within the plant—who regularly traverse the plant facility, inspect plant assets and plant field devices and perform various tasks or procedures for handling operations and maintenance of the plant and/or assets or field devices within the plant. Tasks typically handled by such operators during a work shift may include one or more of concluding tasks specified within task checklists, generating and storing notes concerning tasks that have been carried out, tasks that are in progress or tasks that require to be carried out in future, recording or logging field device readings corresponding to one or more field devices, and generating handwritten logs or notes, or text based, image based, video based or audio based logs or notes using a text editor, a still camera, a video camera or an audio recording apparatus within a mobile client device.

With a view to execute tasks assigned for execution during their work shifts, operators may be provided with mobile client devices having multiple functionalities to enable them to perform their operations and maintenance tasks. FIG. 1, illustrates an exemplary mobile client device 102 of a type that may be assigned to an operator 104. Mobile client device 102 typically includes a hand-held processor implemented device having data processing functionality, and having wired or wireless data networking or data communication capabilities, as well as a user interface to enable an operator 104 to interact with the mobile client device 102 and perform various tasks.

As shown in FIG. 1, exemplary functionality provided by mobile client device 102 may include one or more of generating, storing and completing task checklists 106, generating and storing notes 108 concerning tasks that have been carried out, tasks that are in progress or tasks that require to be carried out in future, recording or logging field device readings 110 corresponding to one or more field devices, and generating image based, video based or audio based logs or notes 112 using a still camera, a video camera or an audio recording apparatus within the mobile client device 102.

Plants that are configured to operate in shifts typically employ different teams of operators for each shift. The team for each work shift normally comprises a shift supervisor and a plurality of operators who may include engineers, maintenance staff, and workers of other designations.

During an assigned work shift within a plant, an operator uses a logbook or a mobile client device (for example, mobile client device 102), to record information corresponding to the current work shift for the various aspects or particular sections of the plant that the operator is in charge of. This typically includes recording on-going task information of one or more activities and recording status information for various equipment as well as recording other operational information that is generated by the plant or by field devices within the plant, and which may be captured by a control system controlling the plant. The information is normally displayed to the operator on an operator console on a client machine or on the mobile client device. Operator comments, evidences of work completion, events deemed significant by the operator, equipment diagrams with handwritten annotations and so on are also commonly maintained by each operator in her/his own paper logbook or in a logbook implemented electronically within mobile client device 102. On top of her/his individual logbook records, each operator may also contribute input to a production summary record that comprises values that are sampled at various time instances.

At the end of every work shift, each operator signs off on her/his own paper or electronic logbook—and this information is stored within one or more electronic data records within a database or centralized repository. A shift supervisor then uses the data recorded and submitted by operators in an outgoing/concluding shift to generate a work shift handover report. The work shift handover report includes (or summarizes) data that is relevant for operational continuity and which needs to be made available to a team of operators who will be operating the plant in the subsequent/incoming work shift. FIG. 2 briefly illustrates this information handover, wherein information recorded by outgoing shift personnel 202 is provided to the shift supervisor/incoming shift personnel 204 in the form of work shift handover information. The shift supervisor/incoming shift personnel 204 may additionally raise questions/clarification requests on the outgoing shift personnel 202—and the responses/clarifications provided by the outgoing shift personnel 202 may comprise part of the overall work shift handover information—which may be recorded in the form of a work shift handover report.

FIG. 3 illustrates a system environment 300 of a type that is typically used for generating and recording work shift handover reports. System environment 300 includes an operations management server 302 configured to interface with one or more operator devices/operator consoles 304a, 304b for receiving operator shift information from outgoing shift operators 306a, and for enabling editing/viewing of such operator shift information (for example in the form of work shift handover reports) by a shift supervisor/incoming shift operator 306b. The operations management server 302 may be configured to generate one or more work shift handover report(s) 308 based on data recorded and submitted by operators in an outgoing/concluding shift. The generated work shift handover report(s) 308 may be generated based on selection of specific data records/data logs by a shift supervisor, and may be viewed by operators within one or more subsequent shifts for the purposes of executing shift related tasks.

FIGS. 4 and 5 illustrate typical approaches in generating a work shift handover report.

In a first approach illustrated in FIG. 4, a first operator (subordinate shift operator #1) generates a first set 402 of work shift data logs or data records (i.e. data logs 12, 14 and 17), while a second operator (subordinate shift operator #2) generates a second set 404 of work shift data logs or data records (i.e. data logs 4, 6 and 9). According to the first approach for generating a work shift handover report, the shift supervisor generates a work shift handover report 406 comprising data logs or data records submitted respectively by the first operator (subordinate shift operator #1) and the second operator (subordinate shift operator #2)—and as a consequence the generated work shift handover report 406 comprises all of data logs 4, 6, 9, 12, 14 and 17.

In a second approach illustrated in FIG. 5, the work shift handover report is generated based on data log selectivity, wherein said selectivity may include application of any one or more selection criteria. In the approach illustrated in FIG. 5, a first operator (subordinate shift operator #1) generates a first set 502 of work shift data logs or data records (i.e. data logs 12, 14 and 17). All of the data logs 12, 14 and 17 submitted by the first operator have been reviewed and approved by the shift supervisor or by any other approving entity. Meanwhile a second shift operator (subordinate shift operator #2) generates a second set 504 of work shift data logs or data records (i.e. data logs 4, 6 and 9)—which have either not yet been reviewed for approval or which have been reviewed but not approved by the shift supervisor or by an approving entity. According to the second approach for generating a work shift handover report, the shift supervisor generates a work shift handover report 506 comprising only work shift data logs or data records that have been approved, as well as one or more data logs or data records submitted by the shift supervisor (i.e. data logs 20 and 21). As a consequence the work shift handover report 506 includes data logs 12, 14, 17, 20 and 21 (but not data logs 4, 6 and 9). It would be understood that the above approaches are only exemplary, and that other methods or approaches may also be used for generating work shift handover reports.

An additional step that is implemented during generation of work shift handover reports within industrial plants, involves selection of specific data records/data logs for inclusion or omission within a work shift handover report based on customized logic/rules/filters (for example based on SQL logic).

FIG. 6 briefly illustrates a method of generating a work shift handover report based on customized logic/rules/filters. Step 602 comprises retrieving operator data records from individual operator work shift reports. Step 604 comprises retrieving additional data records or data logs from one or more databases, based on customized data retrieval instructions. For example, the customized data retrieval instructions may comprise instructions for retrieving from a historical database, historical data log records corresponding to the last n field device readings corresponding to each field device for which a current field device reading is included within an individual operator's work report. Thereafter, step 606 comprises generating a consolidated shift handover report based on the retrieved operator work shift data records (from step 602) as well as the retrieved additional data records (from step 604). Similarly, it would be understood that customized instructions may be used to remove, filter or delete one or more data logs or data records from an individual operator's work shift report—to ensure that such data logs or data records are not included within the consolidated work shift handover report.

The above described arrangements for generation of work shift handover reports can be tedious and time consuming. A shift supervisor is required to manually review and select data logs/data records from each individual operator work shift report for inclusion in the work shift handover report. This is a time consuming task—especially if a shift supervisor is supervising a large number of operators. Additionally, existing solutions do not permit for the shift supervisor to readily review, correlate and select non-text data logs/data records (e.g. audio/image/video based data logs) for inclusion within or for omission from a work shift handover report—and requiring a shift supervisor to review such logs for inclusion/omission would be yet more time and effort intensive.

Yet further, as described in connection with FIGS. 7 and 8 below, existing solutions for generation of work shift handover reports operate in a manner that is complicated and time consuming.

FIG. 7 illustrates an exemplary operations management server 700 that is configured to enable work shift handover report management through a work shift handover report viewer 702 and a log editor 704. The work shift handover report viewer 702 is configured to enable a shift supervisor (or other operator) to review individual operator work shift reports as well as consolidated work shift handover reports generated by the shift supervisor. Log editor 704 is configured to enable the shift supervisor (or other operator) to edit individual data logs or data records. As discussed in more detail below (in connection with FIG. 8), due to the manner in which conventional solutions are configured, when a shift supervisor identifies a data log within an individual operator's work shift report or within a consolidated work shift handover report that requires to be edited, the shift supervisor requires to (i) exit the work shift handover report viewer 702, (ii) launch the log editor 704, (iii) search and select a data log of interest within the log editor 704, (iv) edit the selected data log within the log editor 704, (v) save the edits to the selected data log, (vi) exit the log editor 704, (vii) go back to the shift handover report viewer 702, and (viii) refresh the individual operator work shift report or the consolidated work shift handover report within the shift handover report viewer 702—so that the modification to the selected data log can be viewed within the refreshed individual operator work shift report or the refreshed consolidated work shift handover report.

FIG. 8 is a flowchart illustrating the method steps involved in generating work shift handover reports within conventionally configured operations management servers of the type shown in FIG. 7. Step 802 comprises viewing a work shift handover report within a work shift handover report viewer (e.g. work shift handover report viewer 702 that is implemented within operations management server 700), and identifying a data record of interest within the viewed shift handover report. Step 804 comprises switching to a log editor (e.g. log editor 704 implemented within the operations management server 700)—wherein switching to the log editor comprises the steps of exiting or minimizing the work shift handover report viewer, and launching the log editor.

Step 806 comprises viewing a log list within the log editor and searching for and selecting the identified data record of interest for editing within the log editor.

Step 808 comprises editing and saving changes to the selected data record within the log editor. Step 810 thereafter involves switching back to the work shift handover report viewer-which requires exiting or minimizing the log editor and going back to the work shift handover report viewer. Step 812 comprises refreshing the work shift handover report displayed within the work shift handover report viewer—so that, at step 814, the modifications to the selected data log can be viewed in the refreshed work shift handover report.

It would be understood that as a result of the need to switch between multiple applications (i.e. between the work shift handover report viewer and the log editor), and the number of discrete steps involved, conventional solutions for viewing and modifying data logs within work shift handover reports are time consuming and inefficient.

In view of the above, there is a need for solutions that enable time and effort efficient solutions for generation of work shift handover reports based on individual operator work shift reports submitted at the end of a work shift, as well as for viewing and modifying such work shift handover reports.

### SUMMARY

The present invention provides methods, systems and computer program products that enable management of work shift handover reports within industrial plants.

In an embodiment, the invention provides a method for generating a shift handover report for display. The method may comprise the steps of (i) receiving at a central shift report repository, a plurality of operator shift reports wherein each operator shift report (a) includes shift report data corresponding to one or more shift events recorded during a shift assigned to a shift operator, and (b) is received from a client terminal communicatively coupled with the central shift report repository, (ii) parsing data extracted from each of the received plurality of operator shift reports, and selecting a set of shift report data from the parsed data, wherein selection of the set of shift report data is based on (c) text data, tabular data, image data, audio data or video data, extracted from the parsed data, and (d) output received from a processor implemented decision engine that is configured to (1) receive as input, one or more of text data, tabular data, image data, audio data or video data, parsed from one or more operator shift reports, and (2) output a score indicating suitability of shift report data corresponding to the input text data, tabular data, image data, audio data or video data, for inclusion within a shift handover report, wherein the processor implemented decision engine includes one or more processor implemented classifiers that have been configured based on historical data representing prior selection of shift report data for inclusion within shift handover report(s), (iii) generating, and storing within the central shift report repository, a shift handover report comprising the selected set of shift report data, and (iv) displaying within a user interface rendered on a display, the generated shift handover report comprising the selected set of shift report data.

In a method embodiment, the one or more processor implemented classifiers includes at least a first text classifier configured to classify text data from one or more operator shift reports based on a plurality of text data categories, and wherein said text data comprises any one or more of log description data, log notes description data, log custom data, work instruction data, work instruction notes description data, work instruction custom data, shift handover incoming comment data, shift handover outgoing comment data, shift handover notes description data, shift handover process envelope data comments and shift handover custom data.

In a particular embodiment of the method the first text classifier is configured for classification of text data by implementing (i) a first text classifier configuration step comprising adjusting one or more node weights associated with the first text classifier based on training data obtained from a public dataset, (ii) a second text classifier configuration step comprising adjusting one or more node weights associated with the first text classifier based on vendor specific training data, and (iii) a third text classifier configuration step comprising adjusting one or more node weights associated with the first text classifier based on plant specific training data associated with an industrial plant within which the shift handover report is being generated.

In a specific embodiment of the method, the one or more processor implemented classifiers includes a second deep learning neural network configured for classification of image data, audio data or video data, and wherein the second deep learning neural network text classifier is configured by implementing (i) a first deep learning neural network configuration step comprising adjusting one or more node weights associated with the second deep learning neural network based on vendor specific training data, and (ii) a second deep learning neural network configuration step comprising adjusting one or more node weights associated with the second deep learning neural network based on plant specific training data associated with the industrial plant within which the shift handover report is being generated.

In one embodiment of the method, the one or more processor implemented classifiers includes a third Naive Bayes classifier configured for classification of tabular data, wherein (i) the third Naive Bayes classifier is implemented for classification of tabular data extracted from any of operations management log data, work instruction data, shift handover data, permit to work data, management of change data, and incident management data, (ii) and wherein the third Naive Bayes classifier is configured by adjusting one or more node weights associated with the third Naive Bayes classifier based on plant specific training data associated with the industrial plant within which the shift handover report is being generated.

In a method embodiment, the one or more processor implemented classifiers includes a fourth decision tree classifier configured for classification of tabular data, wherein (i) the fourth decision tree classifier is implemented for classification of tabular data extracted from any of operations management log data, work instruction data, shift handover data, permit to work data, management of change data, and incident management data, (ii) and wherein the fourth decision tree classifier is configured by adjusting one or more node weights associated with the fourth decision tree classifier based on plant specific training data associated with the industrial plant within which the shift handover report is being generated.

In a specific method embodiment, the first text classifier, the second deep learning neural network, the third Naive Bayes classifier and the fourth decision tree classifier are implemented within a processor implemented ensemble model classifier.

In another method embodiment, the selection of the set of shift report data is additionally based on one or more of (i) selection of shift report data from the plurality of operator shift reports based on one or more rules for shift report data selection, and (ii) selection of shift report data from the plurality of operator shift reports based on manual selection inputs received through the user interface.

In a further embodiment of the method, the user interface includes a processor implemented user interface comprising a display interface, wherein said display interface links one or more data records within the selected set of shift report data displayed within the generated shift handover report to a corresponding processor implementable data record viewer or editor, such that selecting a linked data record within the user interface triggers execution of the corresponding processor implementable data record viewer or editor.

In yet another embodiment of the method, the processor implementable data record viewer or editor is displayed as a sub-window within a window of the display interface simultaneously with at least one other window within which the one or more data records within the selected set of shift report data is displayed.

The invention additionally provides a system for generating a shift handover report for display. The system may comprise at least one memory, a central shift report repository, and a processor implemented server communicatively coupled with the memory and the central shift report repository. The processor implemented server may be configured to (i) receive a plurality of operator shift reports wherein each operator shift report (a) includes shift report data corresponding to one or more shift events recorded during a shift assigned to a shift operator, and (b) is received from a client terminal communicatively coupled with the central shift report repository, (ii) parse data extracted from each of the received plurality of operator shift reports, and select a set of shift report data from the parsed data, wherein selection of the set of shift report data is based on (c) text data, tabular data, image data, audio data or video data, extracted from the parsed data, and (d) output received from a processor implemented decision engine that is configured to (1) receive as input, one or more of text data, tabular data, image data, audio data or video data, parsed from one or more operator shift reports, and (2) output a score indicating suitability of shift report data corresponding to the input text data, tabular data, image data, audio data or video data, for inclusion within a shift handover report, wherein the processor implemented decision engine includes one or more processor implemented classifiers that have been configured based on historical data representing prior selection of shift report data for inclusion within shift handover report(s), (iii) generate, and store within the central shift report repository, a shift handover report comprising the selected set of shift report data, and (iv) display within a user interface rendered on a display, the generated shift handover report comprising the selected set of shift report data.

In an embodiment of the system, the one or more processor implemented classifiers includes at least a first text classifier configured to classify text data from one or more operator shift reports based on a plurality of text data categories, and wherein said text data comprises any one or more of log description data, log notes description data, log custom data, work instruction data, work instruction notes description data, work instruction custom data, shift handover incoming comment data, shift handover outgoing comment data, shift handover notes description data, shift handover process envelope data comments and shift handover custom data.

In another embodiment of the system, the first text classifier is configured for classification of text data by implementing (i) a first text classifier configuration step comprising adjusting one or more node weights associated with the first text classifier based on training data obtained from a public dataset, (ii) a second text classifier configuration step comprising adjusting one or more node weights associated with the first text classifier based on vendor specific training data, and (iii) a third text classifier configuration step comprising adjusting one or more node weights associated with the first text classifier based on plant specific training data associated with an industrial plant within which the shift handover report is being generated.

In a specific embodiment of the system, the one or more processor implemented classifiers includes a second deep learning neural network configured for classification of image data, audio data or video data, and wherein the second deep learning neural network text classifier is configured by implementing (i) a first deep learning neural network configuration step comprising adjusting one or more node weights associated with the second deep learning neural network based on vendor specific training data, and (ii) a second deep learning neural network configuration step comprising adjusting one or more node weights associated with the second deep learning neural network based on plant specific training data associated with the industrial plant within which the shift handover report is being generated.

In a particular system embodiment, the one or more processor implemented classifiers includes a third Naive Bayes classifier configured for classification of tabular data, wherein (i) the third Naive Bayes classifier is implemented for classification of tabular data extracted from any of operations management log data, work instruction data, shift handover data, permit to work data, management of change data, and incident management data, (ii) and wherein the third Naive Bayes classifier is configured by adjusting one or more node weights associated with the third Naive Bayes classifier based on plant specific training data associated with the industrial plant within which the shift handover report is being generated.

In an embodiment of the system, the one or more processor implemented classifiers includes a fourth decision tree classifier configured for classification of tabular data, wherein (i) the fourth decision tree classifier is implemented for classification of tabular data extracted from any of operations management log data, work instruction data, shift handover data, permit to work data, management of change data, and incident management data, and (ii) wherein the fourth decision tree classifier is configured by adjusting one or more node weights associated with the fourth decision tree classifier based on plant specific training data associated with the industrial plant within which the shift handover report is being generated.

In another embodiment of the system, the first text classifier, the second deep learning neural network, the third Naive Bayes classifier and the fourth decision tree classifier are implemented within a processor implemented ensemble model classifier.

In a further embodiment of the system, the selection of the set of shift report data is additionally based on one or more of (i) selection of shift report data from the plurality of operator shift reports based on one or more rules for shift report data selection, and (ii) selection of shift report data from the plurality of operator shift reports based on manual selection inputs received through the user interface.

The system may be configured such that the user interface includes a processor implemented user interface comprising a display interface, wherein said display interface links one or more data records within the selected set of shift report data displayed within the generated shift handover report to a corresponding processor implementable data record viewer or editor, such that selecting a linked data record within the user interface triggers execution of the corresponding processor implementable data record viewer or editor.

In a specific embodiment of the system, the processor implementable data record viewer or editor is displayed as a sub-window within a window of the display interface simultaneously with at least one other window within which the one or more data records within the selected set of shift report data is displayed.

The invention also provides a computer program product for optimizing generating a shift handover report for display. The computer program product comprises a non-transitory computer usable medium having a computer readable program code embodied therein, the computer readable program code comprising instructions for implementing within a processor based computing system, the steps of (i) receiving at a central shift report repository, a plurality of operator shift reports wherein each operator shift report (a) includes shift report data corresponding to one or more shift events recorded during a shift assigned to a shift operator, and (b) is received from a client terminal communicatively coupled with the central shift report repository, (ii) parsing data extracted from each of the received plurality of operator shift reports, and selecting a set of shift report data from the parsed data, wherein selection of the set of shift report data is based on (c) text data, tabular data, image data, audio data or video data, extracted from the parsed data, and (d) output received from a processor implemented decision engine that is configured to (1) receive as input, one or more of text data, tabular data, image data, audio data or video data, parsed from one or more operator shift reports, and (2) output a score indicating suitability of shift report data corresponding to the input text data, tabular data, image data, audio data or video data, for inclusion within a shift handover report, wherein the processor implemented decision engine includes one or more processor implemented classifiers that have been configured based on historical data representing prior selection of shift report data for inclusion within shift handover report(s), (iii) generating, and storing within the central shift report repository, a shift handover report comprising the selected set of shift report data, and (iv) displaying within a user interface rendered on a display, the generated shift handover report comprising the selected set of shift report data.

### BRIEF DESCRIPTION OF THE ACCOMPANYING DRAWINGS

FIG. 1 illustrates an exemplary mobile client device of a kind that can be assigned to a field operator within an industrial plant environment.

FIG. 2 illustrates an information handover process, wherein information recorded by outgoing shift personnel is provided to a shift supervisor/incoming shift personnel in the form of work shift handover information.

FIG. 3 illustrates a conventional system environment of a type that is used for generating and recording work shift handover reports.

FIGS. 4 and 5 illustrate methods involved in generating work shift handover reports.

FIG. 6 illustrates a method involved in generating work shift handover reports using customized logic/rules/filters.

FIG. 7 illustrates an operations management server that is configured to implement a work shift handover report viewer and a log editor therewithin.

FIG. 8 is a flowchart illustrating method steps involved in generating work shift handover reports within solutions of the type shown in FIG. 7.

FIG. 9 illustrates a system environment configured in accordance with the teachings of the present invention, for generating and recording work shift handover reports.

FIGS. 10 and 11 are flowcharts respectively illustrating methods in accordance with the teachings of the present invention, for generating and storing work shift handover reports.

FIG. 12 illustrates a decision engine configured in accordance with the teachings of the present invention.

FIG. 13 illustrates an operations management server configured in accordance with the teachings of the present invention, for enabling viewing and modification of data logs within work shift handover reports.

FIG. 14 illustrates components of an operations management server configured in accordance with the teachings of the present invention.

FIG. 15 illustrates components of a decision engine server configured in accordance with the teachings of the present invention.

FIG. 16 illustrates an exemplary computer system according to which various embodiments of the present invention may be implemented.

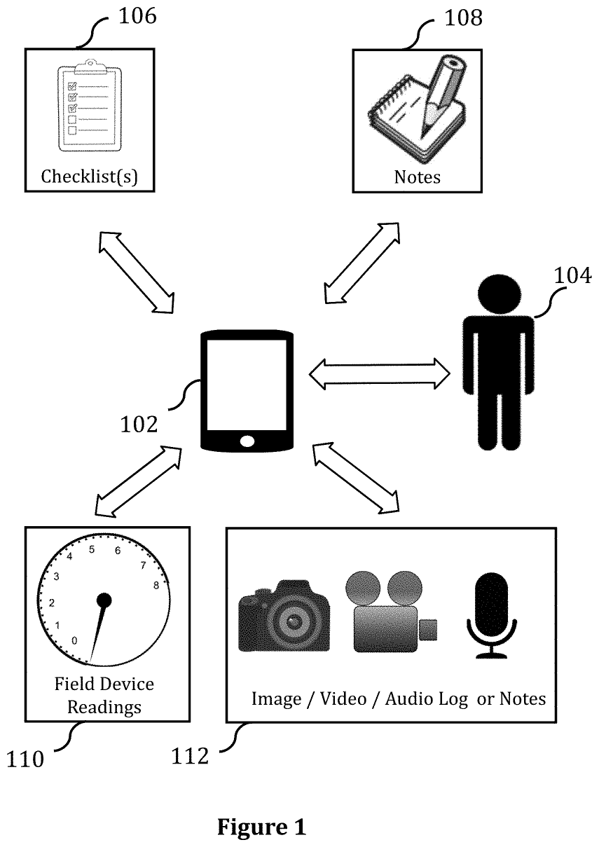

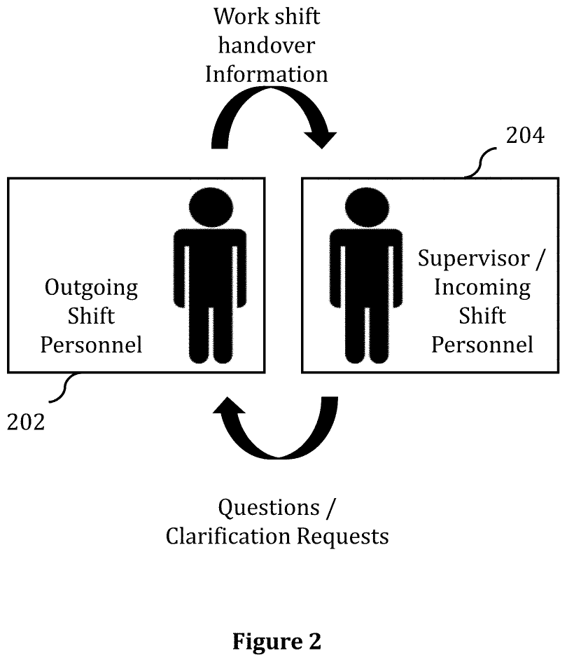

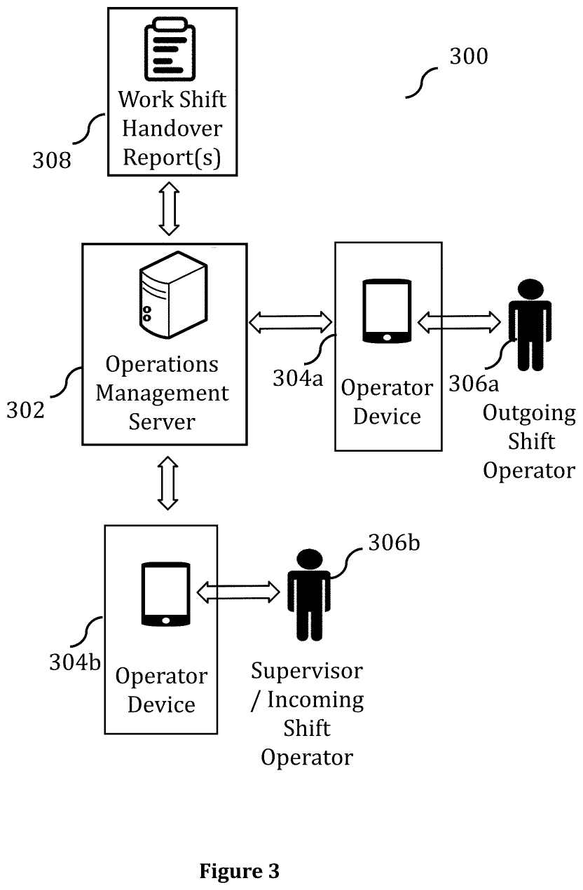

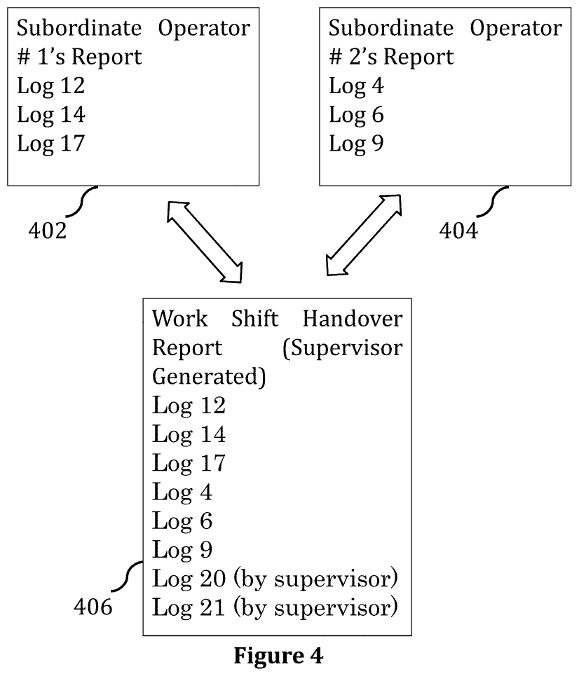

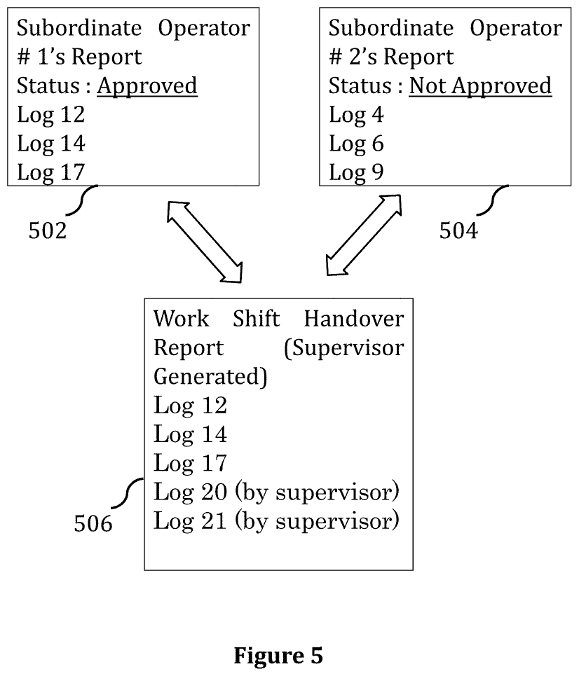

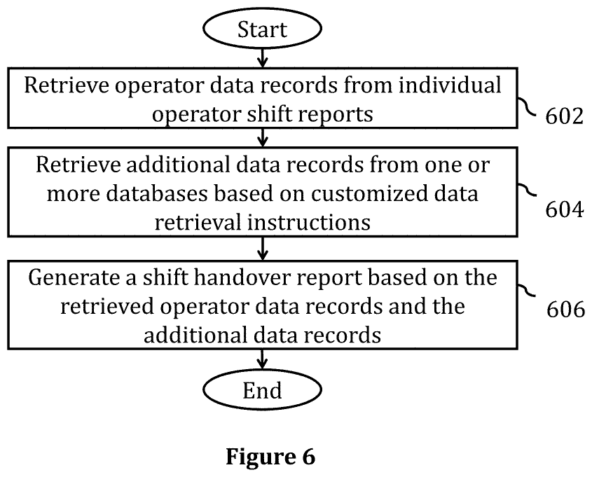

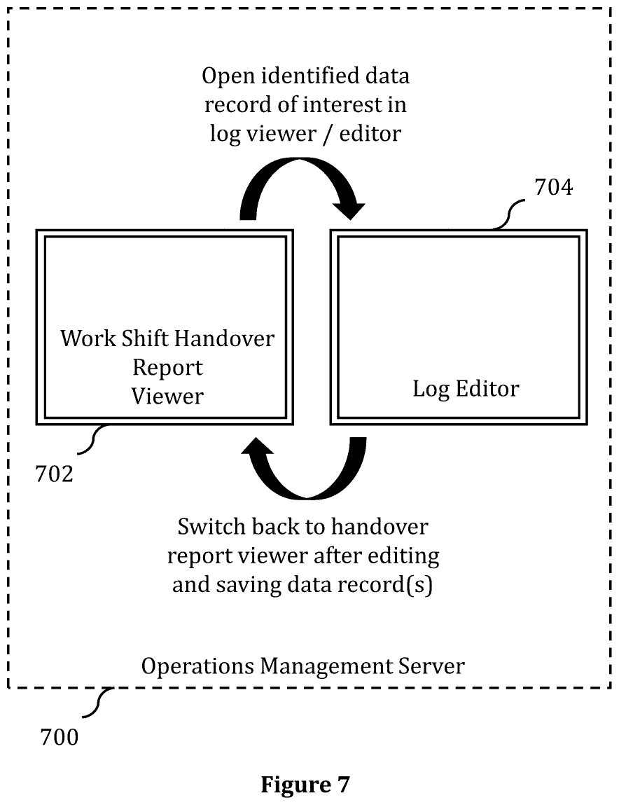

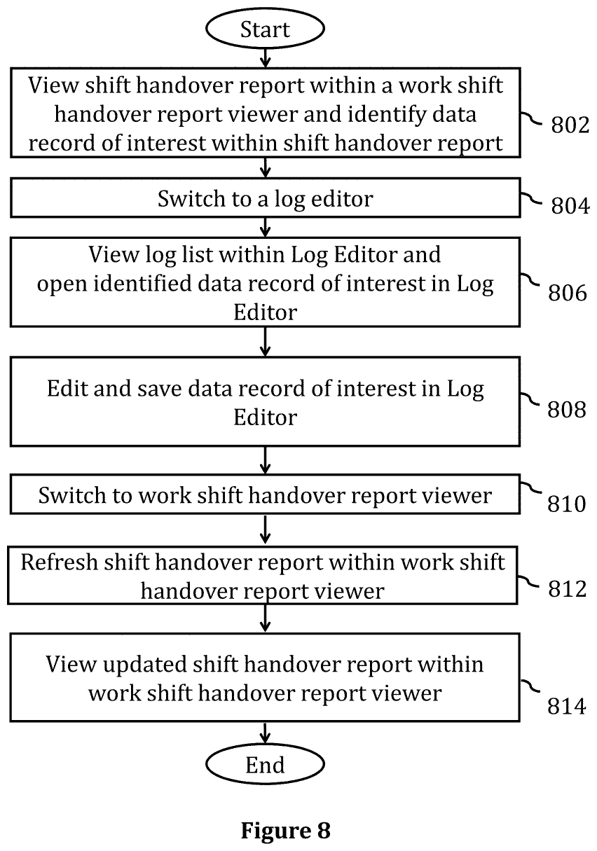

### DETAILED DESCRIPTION

The present invention provides methods, systems and computer program products that enable management of work shift handover reports within industrial plants.

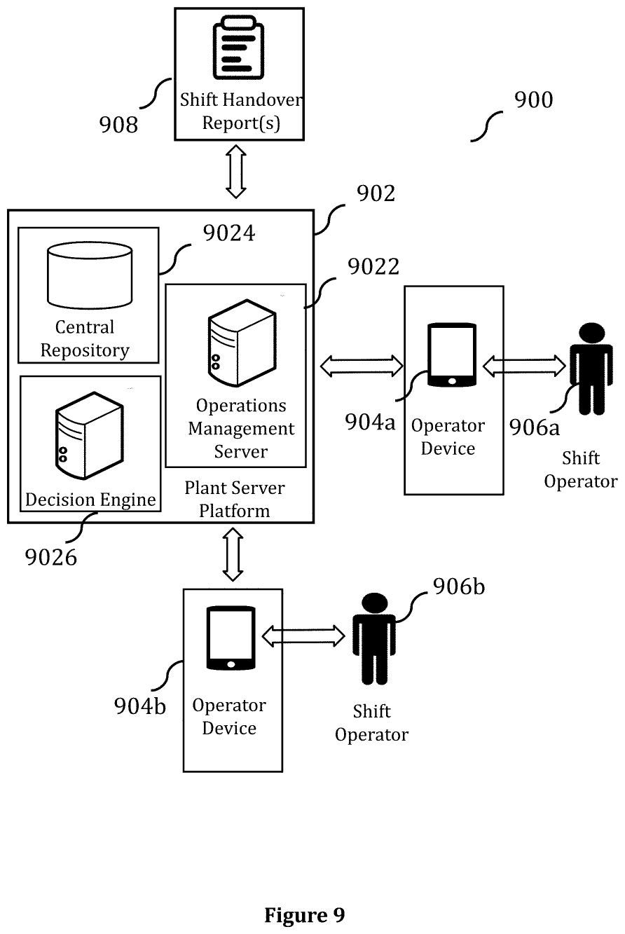

FIG. 9 illustrates a system environment 900 configured in accordance with the teachings of the present invention, for generating and storing work shift handover reports.

System environment 900 includes a plant server platform 902 configured to interface with one or more operator devices/operator consoles 904a, 904b for receiving operator shift reports from outgoing and/or incoming shift operators 906a, 906b and for enabling editing/viewing/consolidating of such operator shift reports (for example in the form of work shift handover reports) by a shift supervisor or other incoming/outgoing shift operators 906a/906b. The plant server platform 902 may be configured to generate one or more work shift handover report(s) 908 based on data (in the form of operator shift reports) recorded and submitted by operators from an outgoing/concluding shift. The generated work shift handover report(s) 908 is generated based on selection of specific data records/data logs from one or more operator shift reports, supervisor logs and/or database records, and may be viewed by operators within one or more subsequent shifts for the purposes of executing shift related tasks.

Plant server platform 902 comprises an operations management server 9022, a decision engine 9026 and a central repository (or database) 9024. Operations management server 9022 comprises a processor implemented server or server system that is configured to interface with one or more operator devices 904a, 904b (or with one or more client devices/remote devices) through which individual shift operators 906a, 906b access operations management server 9022 for submission of individual operator shift reports. Data records/data logs/contents of the submitted individual operator shift reports are stored by operations management server 9022 in central repository 9024, optionally along with data correlating the stored data records/logs/contents with an identifier associated with an operator that has submitted such data records/logs/content.

Decision engine 9026 comprises a processor implemented computing system or server system that is communicatively coupled with operations plant management server 9022 as well as with central repository 9024 and which is configured for selecting from among a plurality of data records/data logs/content submitted by one or more shift operators 906a, 906b, one or more sub-sets of data records/data logs/content for inclusion in a work shift handover report. Decision engine 9026 may be configured in accordance with one or more configurations and/or methods discussed in more detail below, to enable generation of work shift handover reports in a convenient, automated and time efficient manner, so as to minimize the effort and time that a shift supervisor requires to dedicate to generate each work shift handover report.

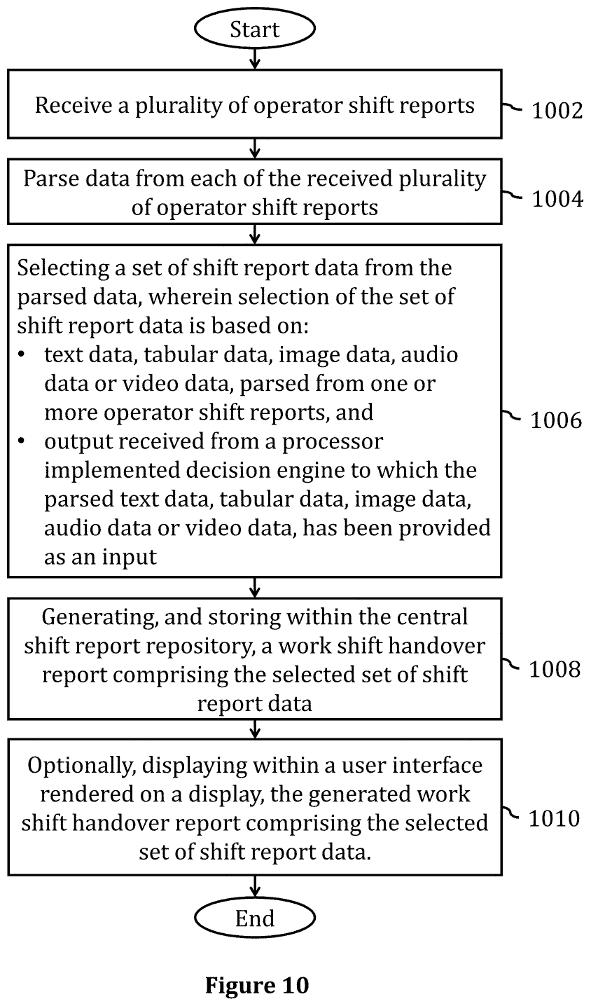

FIG. 10 is a flowchart illustrating a method for generating and recording work shift handover reports, in accordance with the teachings of the present invention. In various embodiments, the method of FIG. 10 may be implemented within any of plant server platform 902, operations management server 9022 or decision engine 9026.

Step 1002 comprises receiving a plurality of operator shift reports. The plurality of operator shift reports may be received from one or more operator devices, client devices, or remote devices from which shift operators input or submit their individual operator shift reports. One or more of the received operator shift reports may include any of text based, image based, video based or audio based logs or notes or readings, or data records generated by an individual shift operator. In an embodiment, the plurality of operator shift reports may be stored in a central repository and receiving them at step 1002 may comprise receiving them from the central repository. In a particular embodiment, the plurality of operator shift reports are received at operations management server 9022.

Step 1004 comprises parsing data within each of the received plurality of operator shift reports. In an embodiment, parsing data within the received plurality of operator shift reports comprises extracting one or more data records or data elements within each of the received plurality of operator shift reports and analyzing or processing the contents of the extracted one or more data records. The parsing of data at step 1004 may in an embodiment be implemented at operations management server 9022.

Step 1006 comprises selecting from the parsed data, a set of operator shift report data, wherein the selection of operator shift report data is based on (i) text data, tabular data, image data, audio data or video data, parsed from one or more operator shift reports, and (ii) one or more outputs received from a processor implemented decision engine to which the parsed text data, tabular data, image data, audio data or video data, has been provided as an input. In an embodiment, the processor implemented decision engine of step 1006 may comprise the decision engine 9026 of FIG. 9. The processor implemented decision engine at step 1006 may in an embodiment comprise a decision engine that is configured to implement machine learning methods and techniques, and that has been trained to receive parsed text data, tabular data, image data, audio data or video data, extracted from one or more operator shift reports, and to provide output indicating whether such text data, tabular data, image data, audio data or video data is (or should be) selected for inclusion within a work shift handover report.

In an embodiment of the invention, the processor implemented decision engine is configured to receive text data, tabular data, image data, audio data or video data extracted and/or parsed from one or more operator shift reports, and to output a score indicating suitability of shift report data corresponding to the input text data, tabular data, image data, audio data or video data, for inclusion within a work shift handover report. Accordingly, in such embodiment, step 1006 comprises selecting from the parsed data, a set of operator shift report data, wherein the selection of operator shift report data is based on (i) text data, tabular data, image data, audio data or video data, parsed from one or more operator shift reports, and (ii) one or more output scores (that indicates suitability of corresponding shift report data for inclusion within a work shift handover report) received from the processor implemented decision engine to which the parsed text data, tabular data, image data, audio data or video data, has been provided as an input.

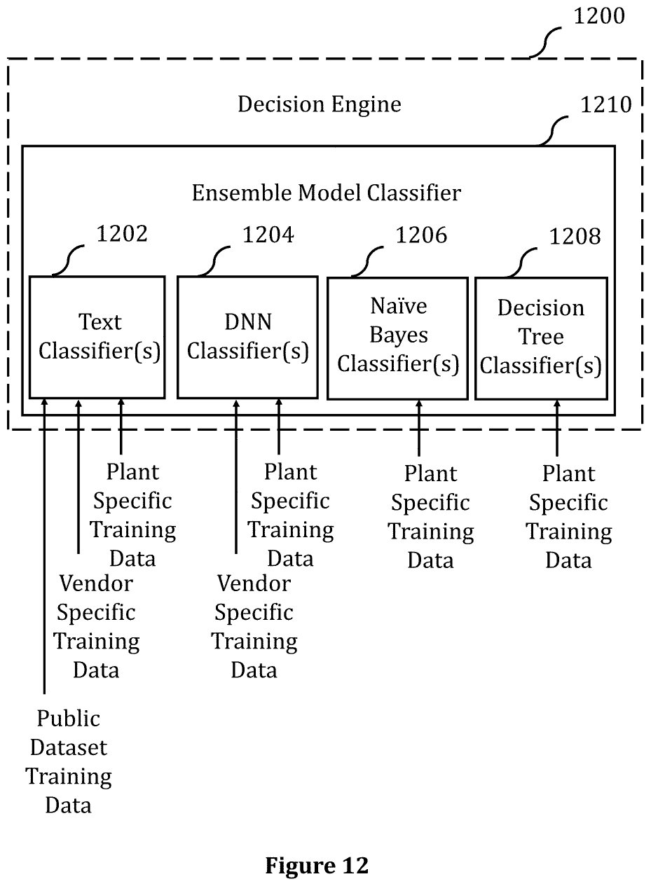

The processor implemented decision engine used within step 1006 may be trained for providing such output (for example, an output score that indicates suitability of corresponding shift report data for inclusion within a work shift handover report) based on one or more of (i) historical data indicating text data, tabular data, image data, audio data or video data that was previously received within one or more operator shift reports, and data indicating whether such text data, tabular data, image data, audio data or video data was selected or rejected for inclusion within a work shift handover report, and (ii) operator training inputs correlating specific instances of text data, tabular data, image data, audio data or video data and whether such specific instances of text data, tabular data, image data, audio data or video data should be included within or excluded from a work shift handover report. More detailed configurations for the processor implemented decision engine of step 1006 are described subsequently in connection with FIG. 12 of this written description.

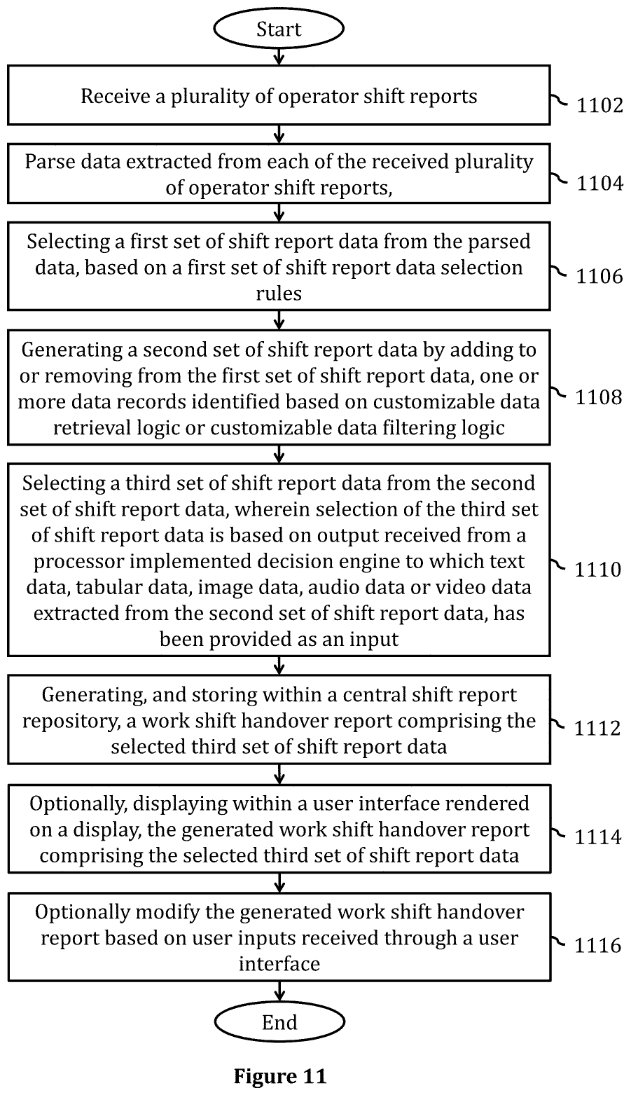

In addition to the selection criteria described above, the selection of a set of shift report data at step 1006 may be based on additional steps, criteria or inputs—embodiments whereof are discussed in more detail in connection with the method of FIG. 11.

Step 1008 comprises generating, and storing within a central shift report repository (e.g. within central repository 9024), a work shift handover report comprising the selected set of shift report data (i.e. the set of shift report data selected at step 1006). In an embodiment, the work shift handover report may be generated by operations management server 9022 and may be transmitted to and stored within central repository 9024.

Step 1010 comprises optionally displaying, within a user interface rendered on a display (for example on a display of an operator device, client device, or remote terminal), the generated work shift handover report comprising the selected set of shift report data. The step of displaying the generated work shift handover report may be implemented by operations management server 9022, by transmitting the work shift handover report to a display device, operator device, client device, or remote terminal for display.

FIG. 11 is a flowchart illustrating a more specific embodiment of the method for generating and recording work shift handover reports that has been described in connection with FIG. 10. In an embodiment, the method of FIG. 11 may be implemented within any of plant platform server 902, operations management server 9022 or decision engine 9026.

Step 1102 comprises receiving a plurality of operator shift reports. The plurality of operator shift reports may be received from one or more operator devices, client devices, or remote devices from which individual shift operators submit their individual operator shift reports. One or more of the received operator shift reports may include any of text based, image based, video based or audio based logs, notes, readings or data records generated by an individual shift operator. In an embodiment, the plurality of operator shift reports may be stored in a central repository and receiving them at step 1102 may comprise receiving them or retrieving them from the central repository. In a particular embodiment, the plurality of operator shift reports are received at operations management server 9022.

Step 1104 comprises parsing data within each of the received plurality of operator shift reports. In an embodiment, parsing data within the received plurality of operator shift reports comprises extracting one or more data records within each of the received plurality of operator shift reports and analyzing or processing the contents of the extracted one or more data records. The parsing of data at step 1104 may in an embodiment be implemented at operations management server 9022.

Step 1106 comprises selecting a first set of shift report data from the parsed data, based on a first set of shift report data selection rules or data selection criteria. The first set of shift report data selection rules may comprise a set of predefined data selection rules and may be retrieved from a database (for example, from central repository 9024). The set of predefined data selection rules may comprise rules for selection of data logs or data records or text data, tabular data, image data, audio data or video data, parsed from one or more operator shift reports, for inclusion within a work shift handover report. For example, a predefined data selection rule may specify that all work shift data logs or data records submitted by shift operators at the end of a shift require to be selected for inclusion within a work shift handover report. In another example, a predefined data selection rule may specify that only work shift data logs or data records that have been submitted by shift operators at the end of a shift and that have been reviewed and approved by a shift supervisor or a reviewing entity require to be selected for inclusion within a work shift handover report.

Step 1108 comprises generating a second set of shift report data by adding to or removing from the first set of shift report data (generated at step 1106), one or more of data logs or data records or text data, tabular data, image data, audio data or video data, that have been identified or selected based on customizable data retrieval logic or customizable data filtering logic. In an embodiment, step 1108 comprises retrieving additional data logs or data records or text data, tabular data, image data, audio data or video data from one or more databases, based on customized data retrieval instructions. For example, the customized data retrieval instructions may comprise instructions for retrieving from a historical database, historical data log records corresponding to the last n field device readings corresponding to each field device for which a current field device reading is included within an individual operator's work report. In another embodiment, step 1108 comprises removing from the first set of shift report data, one or more of data logs or data records or text data, tabular data, image data, audio data or video data, based on customized data filtering logic. For example, the customized data retrieval instructions may comprise instructions for identifying a plurality of field device readings taken from a single field device during a shift, and removing (or filtering out) from the first set of shift report data, all but a single instance of said plurality of field device readings—wherein the retained single instance of the field device reading is the field device reading having the most recent or most current time stamp.

Step 1110 comprises selecting a third set of shift report data from the second set of shift report data, wherein selection of the third set of shift report data is based on output received from a processor implemented decision engine (for example from decision engine 9026) to which text data, tabular data, image data, audio data or video data extracted from the second set of shift report data, has been provided as an input.

The processor implemented decision engine at step 1110 may in an embodiment comprise a decision engine that is configured to implement machine learning methods and techniques, and that has been trained to receive parsed text data, tabular data, image data, audio data or video data, extracted from one or more operator shift reports, and to provide output indicating whether such text data, tabular data, image data, audio data or video data is (or should be) selected for inclusion within a work shift handover report.

In an embodiment of the invention, the processor implemented decision engine is configured to receive text data, tabular data, image data, audio data or video data extracted and/or parsed from one or more operator shift reports, and to output a score indicating suitability of shift report data corresponding to the input text data, tabular data, image data, audio data or video data, for inclusion within a work shift handover report. Accordingly, in such embodiment, step 1110 comprises selecting from the second set of shift report data, a third set of shift report data, wherein the selection of the third set of shift report data is based on (i) text data, tabular data, image data, audio data or video data, parsed from the second set of shift report data, and (ii) one or more output scores (that indicates suitability of corresponding shift report data for inclusion within the third set of shift report data) received from the processor implemented decision engine to which the second set of shift report data has been provided as an input.

The processor implemented decision engine of step 1110 may be trained for providing such output (for example, an output score that indicates suitability of corresponding shift report data for inclusion within a work shift handover report) based on one or more of (i) historical data indicating text data, tabular data, image data, audio data or video data that was previously received within one or more operator shift reports, and data indicating whether such text data, tabular data, image data, audio data or video data was selected or rejected for inclusion within a work shift handover report, and (ii) operator training inputs correlating specific instances of text data, tabular data, image data, audio data or video data and whether such specific instances of text data, tabular data, image data, audio data or video data should be included within or excluded from a work shift handover report. More detailed configurations for the processor implemented decision engine of step 1110 are discussed subsequently in connection with FIG. 12 of this description.

Step 1112 comprises generating, and storing within a shift report repository (e.g. within central repository 9024), a work shift handover report comprising the selected third set of shift report data (i.e. the third set of shift report data generated or selected at step 1110). In an embodiment, the work shift handover report may be generated by operations management server 9022 and may be transmitted to and stored within central repository 9024.

Step 1114 comprises optionally displaying within a user interface rendered on a display (for example on a display of an operator device, client device, or remote terminal), the generated work shift handover report comprising the selected third set of shift report data. The step of displaying the generated work shift handover report may be implemented by operations management server 9022, by transmitting the generated work shift handover report to a display device, operator device, client device, or remote terminal for display.

Step 1116 comprises optionally modifying the generated work shift handover reports based on user inputs received through a user interface. In embodiment, step 1116 includes receiving one or more user inputs (for example, inputs from an operator or shift supervisor) indicating any of (i) one or more additional data records/data logs/content that requires to be added within the generated work shift handover report, or (ii) one or more data records/data logs/content that requires to be removed from the generated work shift handover report, or (iii) one or more modifications to any data records/data logs/content that are already included within the generated work shift handover report. The generated work shift handover report is thereafter modified based on the received user inputs—for example, by adding, removing or modifying one or more data records/data logs/content, based on the received user inputs.

It would be understood that step 1116 enables user implemented or user supervised fine tuning or modification of work shift handover reports that have been generated in accordance with the teachings of the present invention.

FIG. 12 illustrates a decision engine 1200 configured in accordance with the teachings of the present invention. In an embodiment of the invention, the decision engine 9026 illustrated within FIG. 9 may be implemented with the configuration illustrated and discussed in connection with FIG. 12.

Decision engine 1200 may comprise a processor implemented decision engine, and may be configured to implement an ensemble model classifier 1210. Ensemble model classifier 1210 comprises a plurality of classifiers, including one or more of at least one text classifier(s) 1202, at least one deep neural network (DNN) classifier(s) 1204, at least one naïve bayes classifier(s) 1206 and at least one decision tree classifier(s) 1208. In an embodiment, ensemble model classifier 1210 comprises a plurality of classifiers, including all of at least one text classifier(s) 1202, at least one deep neural network (DNN) classifier(s) 1204, at least one naïve bayes classifier(s) 1206 and at least one decision tree classifier(s) 1208. One or more of the at least one text classifier(s) 1202, the at least one deep neural network (DNN) classifier(s) 1204, the at least one naïve bayes classifier(s) 1206, and the at least one decision tree classifier(s) 1208 may be pluggable classifiers which can be added, removed or substituted within ensemble model classifier 1210 without affecting the operation of other classifiers within the ensemble model classifier 1210.

The at least one text classifier(s) 1202 may comprise one or more than one text classifiers integrated into a processor implemented text classifier container. In an embodiment, text classifier(s) 1202 comprises one or more of a bidirectional encoder representations from transformers (BERT) classifier, a GPT-2 text classifier, and a long short-term memory (LSTM) classifier.

The at least one text classifier(s) 1202 is trained or configured in a multi-stage configuration process. In a first stage, the at least one text classifier(s) 1202 is pre-trained based on training data received from a public dataset—i.e. the node weights within the at least one text classifier(s) 1202 are selected or assigned based on training data received from a public dataset. In an embodiment, the public dataset may comprise one or more datasets obtained from Natural Language Processing (NLP) or Bidirectional Encoder Representations from Transformers (BERT). Any text, including text which is available on the internet could be used for text classifier training—for example, text in Wikipedia, or text from published novels or documents. Such public dataset text is used train the text classifiers.

In a second stage, the at least one text classifier(s) 1202 is iteratively trained or refined based on a vendor specific dataset comprising vendor specific training data—i.e. the node weights within the at least one text classifier(s) 1202 are iteratively modified or adjusted selected on a vendor specific dataset. In an embodiment, the vendor specific dataset may comprise one or more datasets that include vendor specific data gathered from various projects or plant. Vendor specific data could include any of alarm data, process data, log data, operation management data, and/or distributed control system (DCS) data from a company's own database. The vendor specific data is not necessarily related to any specific plant.

In a third stage, the at least one text classifier(s) 1202 is iteratively trained or refined based on a plant specific dataset comprising plant specific training data—i.e. the node weights within the at least one text classifier(s) 1202 are iteratively modified or adjusted selected on plant specific training data. In an embodiment, the plant specific dataset may include any of existing e-log book data, work instruction data, permit to work data, management of change data, incident management data, video data, image data and/or audio data pertaining to a specific plant.

In an embodiment, decision engine 1200 is configured such that the at least one text classifier(s) 1202 is configured to classify text data from one or more operator shift reports based on a plurality of text data categories, and wherein said text data comprises any one or more of log description data, log notes description data, log custom data, work instruction data, work instruction notes description data, work instruction custom data, shift handover incoming comment data, shift handover outgoing comment data, shift handover notes description data, shift handover process envelope data comments and shift handover custom data, that have been received as part of the one or more operator shift reports.

The at least one DNN classifier(s) 1204 may comprise one or more than one DNN classifiers integrated into a processor implemented DNN classifier container.

The at least one DNN classifier(s) 1204 is trained or configured in a multi-stage configuration process. In a first stage, the at least one DNN classifier(s) 1204 is trained based on a vendor specific dataset comprising vendor specific training data—i.e. the node weights within the at least one DNN classifier(s) 1204 are iteratively modified or adjusted selected on vendor specific training data. In an embodiment, the vendor specific dataset may comprise one or more datasets that include vendor specific data gathered from various projects or plant. Vendor specific data could include any of alarm data, process data, log data, operation management data, and/or distributed control system (DCS) data from a company's own database. The vendor specific data is not necessarily related to any specific plant.

In a second stage, the at least one DNN classifier(s) 1204 is iteratively trained or refined based on a plant specific dataset comprising plant specific training data—i.e. the node weights within the at least one DNN classifier(s) 1204 are iteratively modified or adjusted selected on plant specific training data. In an embodiment, the plant specific dataset may include any of existing e-log book data, work instruction data, permit to work data, management of change data, incident management data, video data, image data and/or audio data pertaining to a specific plant.

In an embodiment, decision engine 1200 is configured such that the at least one DNN classifier(s) 1204 is configured to (i) classify image data from one or more operator shift reports based on a plurality of image data categories, and wherein said image data comprises image data received within image files or within one or more video files, that have been received as part of the one or more operator shift reports or supervisor shift reports, and/or (ii) classify audio data from one or more operator shift reports based on a plurality of audio data categories, and wherein said audio data comprises audio data received within audio files or within one or more video files, that have been received as part of the one or more operator shift reports or supervisor shift reports. In an embodiment, the image data and/or audio data may include audio data or video data extracted from the one or more video files.

The at least one naïve bayes classifier(s) 1206 may comprise one or more than one naïve bayes classifiers integrated into a processor implemented naïve bayes classifier container.

The at least one naïve bayes classifier(s) 1206 is trained iteratively based on a plant specific dataset comprising plant specific training data—i.e. the node weights within the at least one naïve bayes classifier(s) 1206 are iteratively modified or adjusted selected on plant specific training data. In an embodiment, the plant specific dataset may include any of existing e-log book data, work instruction data, permit to work data, management of change data, incident management data, video data, image data and/or audio data pertaining to a specific plant.

In an embodiment, decision engine 1200 is configured such that the at least one naïve bayes classifier(s) 1206 is configured to classify tabular data extracted from any of operations management log data, work instruction data, shift handover data, permit to work data, management of change data, and incident management data, that have been received as part of the one or more operator shift reports, or supervisor shift reports.

The at least one decision tree classifier(s) 1208 may comprise one or more than one decision tree classifiers integrated into a processor implemented decision tree classifier container.

In an embodiment, the at least one decision tree classifier(s) 1208 comprises one or more of a random forecast tree classifier, a logistic regression classifier, a light gradient boosting (LGBM) classifier, and an XGBOOST classifier.

The at least one decision tree classifier(s) 1208 is trained iteratively or refined based on a plant specific dataset comprising plant specific training data—i.e. the node weights within the at least one decision tree classifier(s) 1208 are iteratively modified or adjusted selected on plant specific training data. In an embodiment, the plant specific dataset may include any of existing e-log book data, work instruction data, permit to work data, management of change data, incident management data, video data, image data and/or audio data pertaining to a specific plant.

In an embodiment, decision engine 1200 is configured such that the at least one decision tree classifier(s) 1208 is configured to classify tabular data extracted from any of operations management log data, work instruction data, shift handover data, permit to work data, management of change data, and incident management data, that have been received as part of the one or more operator shift reports, or supervisor shift reports.

It would be understood that once the individual classifiers within ensemble model classifier 1210 are trained and implemented, their respective pluggable configurations ensures that any one or more individual classifiers may at any time be added, removed, substituted or modified within decision engine 1200 without affecting the operation of any other classifiers. Additionally any one or more individual classifiers within ensemble model classifier 1210 may be periodically retrained or reconfigured based on historical operator shift data, supervisor shift data or work shift handover report data generated within the industrial plant where decision engine 1200 has been implemented. In certain embodiments, individual classifiers are periodically retrained or reconfigured through an online module that iteratively trains said classifiers based on additional operator shift data, supervisor shift data or work shift handover report data.

As described in connection with FIG. 9, decision engine 1200 may in an embodiment comprise a processor implemented computing system or server system that is communicatively coupled with an operations plant management server (e.g. operations management server 9022) and which is configured for selecting from among a plurality of data records/data logs/content submitted by one or more shift operators, one or more sub-sets of data records/data logs/content for inclusion in a work shift handover report. The selection of data records/data logs/content may be implemented by extracting data from said data records/data logs/content and selectively providing such data as input to the one or more classifiers 1202 to 1208 within ensemble model classifier 1210, and by selecting or rejecting such data for inclusion within a work shift handover report based on the corresponding output (for example, based on an output score that indicates suitability of the data extracted from said data records/data logs/content for inclusion within a work shift handover report) from each of said one or more classifiers 1202 to 1208.

Based on the above, it would be understood that the invention enables use of past historical data of previous shift handover reports, in which supervisors select or exclude records such as logs and work instructions from the new reports. This data may include reports from subordinates and supervisors/approvers, and/or all record data (including records corresponding to task or event priority, task or event status, record creator, etc). The decision engine is configured to iteratively learn how records are included or excluded by supervisors in previous reports, so it can automatically classify new records to be included in new shift handover reports.

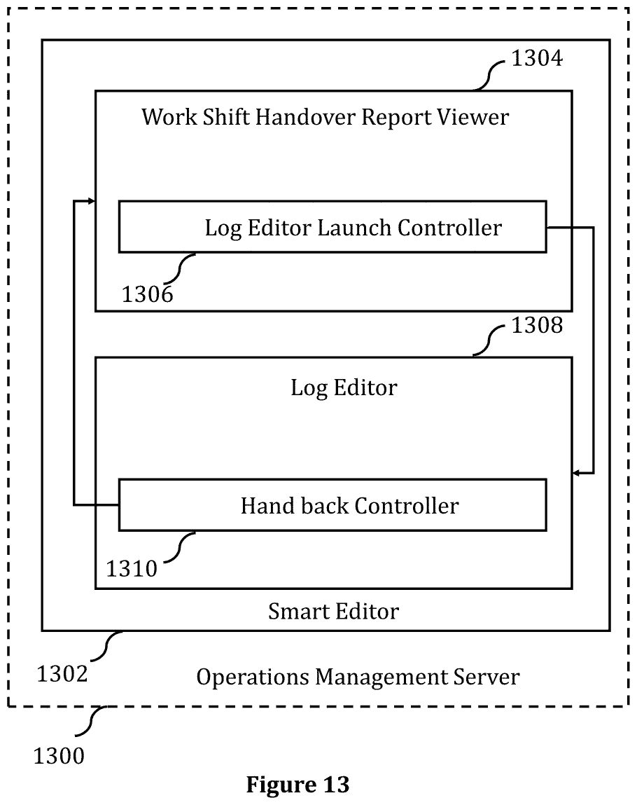

FIG. 13 illustrates an embodiment of an operations management server 1300 configured in accordance with the teachings of the present invention, for enabling viewing and modification of data logs within work shift handover reports. Operations management server 1300 may be configured for work shift handover report management through a processor implemented smart editor 1302. In an embodiment, the operations management server 1300 may be implemented within the plant server platform 902 of FIG. 9.

In the illustrated embodiment of FIG. 13, the processor implemented smart editor 1302 includes a processor implemented work shift handover report viewer 1304 and a processor implemented log editor 1308.

Work shift handover report viewer 1304 is configured to enable a shift supervisor (or other operator) to review individual operator shift reports as well as consolidated work shift handover reports generated by the shift supervisor. Work shift handover report viewer 1304 enables this functionality by providing a user interface through which data records/data logs (within individual operator shift reports as well as within consolidated work shift handover reports generated by a shift supervisor) can be displayed on a processor implemented display device. Additionally work shift handover report viewer 1304 is configured to include or interface with a log editor launch controller 1306—wherein, in response to a user, operator or shift supervisor providing an instruction for editing a specific data record or data log that is on display within shift handover report viewer 1304, said log editor launch controller 1306 initiates launch of log editor 1308 from within the shift handover report viewer 1304 (preferably as a sub-window within shift handover report viewer 1304) and additionally initiates opening of the specific data record or data log within the log editor 1308 to enable editing or modification of said data record or data log.

Log editor 1308 is configured to enable the shift supervisor (or other operator) to edit individual data logs or data records and to save modifications to edited individual data logs or data records within a database or data repository. Log editor 1308 is additionally configured (i) to be triggered or initiated by log editor launch controller 1306, (ii) to receive from log editor launch controller 1306 data identifying one or more data logs or data records that have been selected by a user, operator or shift supervisor through work shift handover report viewer 1304 for the purposes of modification, and (iii) opening the identified one or more data logs or data records on launch of log editor 1308 to enable a user, operator or shift supervisor to modify said data logs or data records.

Additionally log editor 1308 is configured to include or interface with a hand back controller 1310—wherein in response to a user, operator or shift supervisor providing an input or instruction to terminate a specific data log modification session, said hand back controller 1310 initiates termination or closure of log editor 1308, and hands over control of the interface or session back to shift handover report viewer 1304, and optionally refreshes shift handover report viewer 1304 so that any modifications that have been made to one or more data logs within log editor 1308 are viewable within shift handover report viewer 1304.

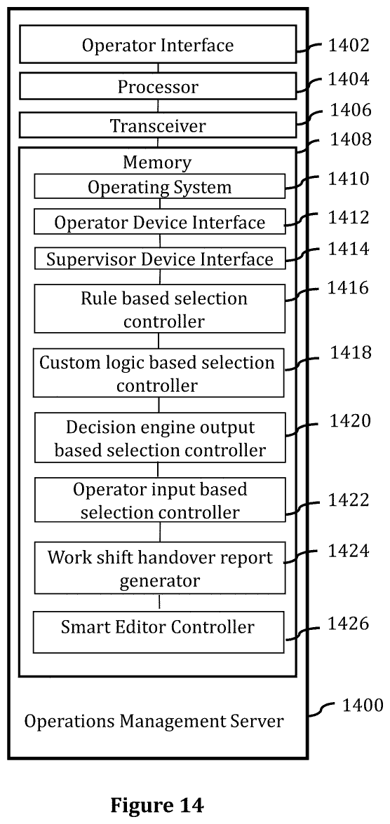

FIG. 14 illustrates components of an operations management server 1400 configured in accordance with the teachings of the present invention. In an embodiment, operations management server 1400 may be configured to implement the functionality of operations management server 9022 described in connection with FIG. 9.

Operations management server 1400 comprises (i) an operator interface 1402 configured to enable an operator (for example, a shift operator, shift supervisor or other console operator, SysOp or DevOp) to interface with and control operations management server 1400 (ii) a processor 1404, (iii) a transceiver 1406 configured to send and receive data communications over a data network (for example a TCP/IP network, the internet, or any other data network) to enable operations management server 1400 to communicate with any other network communication enabled device, and (iv) a transient or non-transient memory 1408.

Memory 1408 may include therewithin an operating system 1410 configured for managing device hardware and software resources and that provides common services for software programs implemented within operations management server 1400. Memory 1408 may additionally include a processor implemented operator device interface 1412 that is configured to enable initiation, termination and session control of one or more communication sessions, data transfer sessions and/or data synchronization sessions between operations management server 1400 and one or more operator devices (e.g. the operator devices 904a, 904b of FIG. 9).

Memory 1408 may also include a processor implemented supervisor device interface 1414 that is configured to enable initiation, termination and session control of one or more communication sessions, data transfer sessions and/or data synchronization sessions between operations management server 1400 and one or more supervisor devices (i.e. remote devices or client devices through which a shift supervisor accesses operations management server 1400).

Memory 1408 includes a rule based selection controller 1416 configured for selecting a first set of shift report data parsed from one or more operator shift reports, based on a first set of shift report data selection rules or data selection criteria. The first set of shift report data selection rules may comprise a set of predefined data selection rules and may be retrieved from a database. The set of predefined data selection rules may comprise rules for selection of data logs or data records or text data, tabular data, image data, audio data or video data, parsed from one or more operator shift reports, for inclusion within a work shift handover report. For example, a predefined data selection rule may specify that all work shift data logs or data records submitted by shift operators at the end of a shift are required to be selected for inclusion within a work shift handover report. In another example, a predefined data selection rule may specify that only work shift data logs or data records that have been submitted by shift operators at the end of a shift and that have been reviewed and approved by a shift supervisor or a reviewing entity are required to be selected for inclusion within a work shift handover report. In an embodiment, the rule based selection controller 1416 may be configured to implement method step 1106 of the method of FIG. 11.

Memory 1408 further includes a custom logic based selection controller 1418 configured for generating a second set of shift report data by adding to or removing from the first set of shift report data (generated by rule based selection controller 1416), one or more of data logs or data records or text data, tabular data, image data, audio data or video data, that have been identified or selected based on customizable data retrieval logic or customizable data filtering logic. In an embodiment, custom logic based selection controller retrieving additional data logs or data records or text data, tabular data, image data, audio data or video data from one or more databases, based on customized data retrieval instructions. For example, the customized data retrieval instructions may comprise instructions for retrieving from a historical database, historical data log records corresponding to the last n field device readings corresponding to a field device for which a current field device reading is included within an individual operator's work report. In another embodiment, custom logic based selection controller 1418 may be configured to remove from the first set of shift report data, one or more of data logs or data records or text data, tabular data, image data, audio data or video data, based on customized data filtering logic. For example, the customized data retrieval instructions may comprise instructions for identifying a plurality of field device readings taken from a single field device during a shift, and removing of filtering out from the first set of shift report data, all but a single instance of said plurality of field device readings—wherein the retained single instance of the field device reading is the field device reading having the most recent or most current time stamp. In an embodiment, the custom logic based selection controller 1418 may be configured to implement method step 1108 of the method of FIG. 11.

Memory 1408 also includes a decision engine output based selection controller 1420, configured to enable selection of a third set of shift report data from the second set of shift report data, wherein selection of the third set of shift report data is based on output received from a processor implemented decision engine to which text data, tabular data, image data, audio data or video data extracted from the second set of shift report data, has been provided as an input. Said processor implemented decision engine may in an embodiment comprise a decision engine that is configured to implement machine learning methods and techniques, and that has been trained to receive parsed text data, tabular data, image data, audio data or video data, extracted from one or more operator shift reports, and to provide output indicating whether such text data, tabular data, image data, audio data or video data is (or should be) selected for inclusion within a work shift handover report.

In an embodiment of the invention, the processor implemented decision engine is configured to receive text data, tabular data, image data, audio data or video data extracted and/or parsed from one or more operator shift reports, and to output a score indicating suitability of shift report data corresponding to the input text data, tabular data, image data, audio data or video data, for inclusion within a work shift handover report.

Further, the processor implemented decision engine may be trained for providing such output based on one or more of (i) historical data indicating text data, tabular data, image data, audio data or video data that was previously received within one or more operator shift reports and data indicating whether such text data, tabular data, image data, audio data or video data was selected or rejected for inclusion within a work shift handover report, and (ii) operator training inputs correlating specific instances of text data, tabular data, image data, audio data or video data and whether such specific instances of text data, tabular data, image data, audio data or video data should be included within or excluded from a work shift handover report.

In addition, memory 1408 includes an operator input based selection controller 1422, configured to enable modifying of generated work shift handover reports based on user inputs received through a user interface. In an embodiment, operator input based selection controller 1422 is configured to receive one or more user inputs (for example, inputs from an operator or shift supervisor) indicating any of (i) one or more additional data records/data logs/content that are required to be added inclusion within the generated work shift handover report, or (ii) one or more additional data records/data logs/content that are required to be removed from the generated work shift handover report, or (iii) one or more modifications to any data records/data logs/content that are already included within the generated work shift handover report. A generated work shift handover report is thereafter modified based on the received user inputs—for example, by adding, removing or modifying one or more data records/data logs/content, based on the received user inputs. It would be understood that the configuration of operator input based selection controller 1422 inputs fine tuning or modification based on actual user inputs, of a work shift handover report that has been generated in accordance with the machine learning based, and automated, methods of the present invention. In an embodiment, operator input based selection controller 1422 may be configured to implement method step 1116 of the method of FIG. 11.

Memory 1408 also includes a work shift handover report generator 1424 configured to generate and storing within a central shift report repository, a work shift handover report comprising a set of shift report data comprising data logs or data records selected by one or more of rule based selection controller 1416, custom logic based selection controller 1418, decision engine output based selection controller 1420, and operator input based selection controller 1422. In an embodiment, work shift handover report generator 1424 may be configured to implement method step 1112 of the method of FIG. 11.

Memory 1408 further includes a smart editor controller 1426 configured to implement a smart editor of the kind illustrated and described previously in connection with FIG. 12.

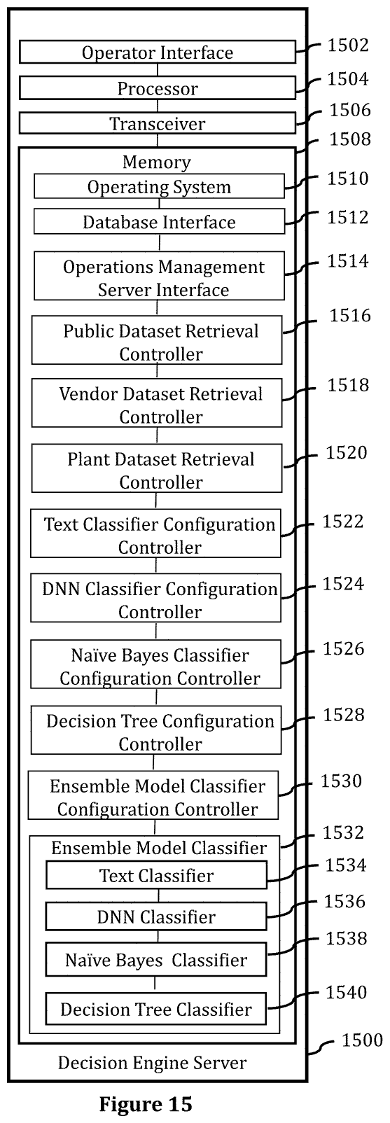

FIG. 15 illustrates components of a decision engine server 1500 configured in accordance with the teachings of the present invention.

Decision engine server 1500 comprises (i) an operator interface 1502 configured to enable an operator (for example, a shift operator, shift supervisor or other console operator, SysOp or DevOp) to interface with and control decision engine server 1500, (ii) a processor 1504, (iii) a transceiver 1506 configured to send and receive data communications over a data network (for example a TCP/IP network, the internet, or any other data network) to enable decision engine server 1500 to communicate with any other network communication enabled device, and (iv) a transient or non-transient memory 1508.

Memory 1508 may include therewithin an operating system 1510 configured for managing device hardware and software resources and that provides common services for software programs implemented within decision engine server 1500. Memory 1508 may additionally include a processor implemented database interface 1512 configured to enable initiation, termination and session control of one or more communication sessions, data transfer sessions and/or data synchronization sessions between decision engine server 1500 and one or more databases (e.g. central repository 9024 of FIG. 9).

Memory 1508 may also include a processor implemented operations management server interface 1514 that is configured to enable initiation, termination and session control of one or more communication sessions, data transfer sessions and/or data synchronization sessions between decision engine server 1500 and an operations management server (e.g. operations management server 9022 of FIG. 9 or operations management server 1400 of FIG. 14).

Memory 1508 further includes a public dataset retrieval controller 1516, configured to access and retrieve data from one or more public datasets for training text classifier(s) implemented within decision engine server 1500. Memory 1508 also includes a vendor dataset retrieval controller 1518, configured to access and retrieve data from one or more vendor datasets for training text classifier(s) and/or DNN classifier(s) implemented within decision engine server 1500. Memory 1508 yet further includes a plant dataset retrieval controller 1520, configured to access and retrieve data from one or more plant datasets for training text classifier(s), DNN classifier(s), naïve bayes classifiers and decision tree classifiers implemented within decision engine server 1500.

In addition to the above, memory 1508 may include (i) text classifier configuration controller 1522 configured to enable training of one or more text classifier(s) implemented within decision engine server 1500 based on one or more of data from public datasets, data from vendor datasets and data from plant datasets, (ii) DNN classifier configuration controller 1524 configured to enable training of one or more DNN classifier(s) implemented within decision engine server 1500 based on one or more of data from vendor datasets and data from plant datasets, (iii) naïve bayes classifier configuration controller 1526 configured to enable training of one or more naïve bayes classifier(s) implemented within decision engine server 1500 based on data from one or more plant datasets, (iv) decision tree classifier configuration controller 1528 configured to enable training of one or more decision tree classifier(s) implemented within decision engine server 1500 based on data from one or more plant datasets, and (v) ensemble model classifier configuration controller 1530 configured to enable training of an ensemble model classifier implemented within decision engine server 1500.

Memory 1508 also includes a processor implemented ensemble model classifier 1532 comprising one or more of text classifier 1534, DNN classifier 1536, naïve bayes classifier 1538 and decision tree classifier 1540. In various embodiments of the invention, one or more of text classifier 1534, DNN classifier 1536, naïve bayes classifier 1538 and decision tree classifier 1540 and ensemble model classifier 1532 may be configured in accordance with the classifier configurations discussed in more detail above in connection with decision engine 1200 of FIG. 12.

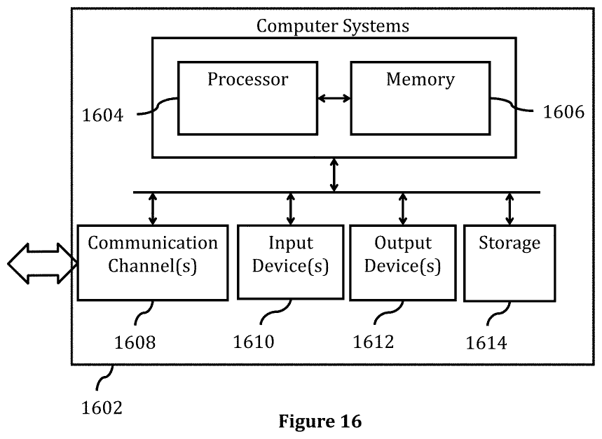

FIG. 16 illustrates an exemplary computer system 1600 according to which various embodiments of the present invention may be implemented.

System 1600 includes computer system 1602 which in turn comprises one or more processors 1604 and at least one memory 1606. Processor 1604 is configured to execute program instructions—and may be a real processor or a virtual processor. It will be understood that computer system 1602 does not suggest any limitation as to scope of use or functionality of described embodiments. The computer system 1602 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1602 in accordance with the present invention may include one or more servers, desktops, laptops, tablets, smart phones, mobile phones, mobile communication devices, tablets, phablets and personal digital assistants. In an embodiment of the present invention, the memory 1606 may store software for implementing various embodiments of the present invention. The computer system 1602 may have additional components. For example, the computer system 1602 may include one or more communication channels 1608, one or more input devices 1610, one or more output devices 1612, and storage 1614. An interconnection mechanism (not shown) such as a bus, controller, or network, interconnects the components of the computer system 1602. In various embodiments of the present invention, operating system software (not shown) provides an operating environment for various softwares executing in the computer system 1602 using a processor 1604, and manages different functionalities of the components of the computer system 1602.

The communication channel(s) 1608 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1610 may include, but is not limited to, a touch screen, a keyboard, mouse, pen, joystick, trackball, a voice device, a scanning device, or any another device that is capable of providing input to the computer system 1602. In an embodiment of the present invention, the input device(s) 1610 may be a sound card or similar device that accepts audio input in analog or digital form. The output device(s) 1612 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1602.

The storage 1614 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1602. In various embodiments of the present invention, the storage 1614 may contain program instructions for implementing any of the described embodiments.

In an embodiment of the present invention, the computer system 1602 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1602. The method described herein is typically implemented as a computer program product, comprising a set of program instructions that is executed by the computer system 1602 or any other similar device. The set of program instructions may be a series of computer readable codes stored on a tangible medium, such as a computer readable storage medium (storage 1614), for example, diskette, CD-ROM, ROM, flash drives or hard disk, or transmittable to the computer system 1602, via a modem or other interface device, over either a tangible medium, including but not limited to optical or analogue communications channel(s) 1608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages. In particular, the invention provides automated solutions for optimally generating work shift handover reports based on individual operator shift reports. —with significant improvements with respect to efficiencies of time and effort inputs required on the part of a shift supervisor. The invention provides automated solutions that also enable a shift supervisor to readily review, correlate and select non-text data logs/data records (e.g. audio/image/video based data logs) for inclusion within or for omission from a work shift handover report. Yet further, the invention provides user friendly solutions for viewing and modifying data logs within work shift handover reports, are time and effort efficient.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

We claim:

1. A method for generating a shift handover report for display, the method comprising the steps of:
receiving at a central shift report repository, a plurality of operator shift reports wherein each operator shift report:
includes shift report data corresponding to one or more shift events recorded during a shift assigned to a shift operator; and
is received from a client terminal communicatively coupled with the central shift report repository;
parsing data extracted from each of the received plurality of operator shift reports, and selecting a set of shift report data from the parsed data, wherein selection of the set of shift report data is based on:
text data, tabular data, image data, audio data or video data, extracted from the parsed data; and
output received from a processor implemented decision engine that is configured to:
receive as input, one or more of text data, tabular data, image data, audio data or video data, parsed from one or more operator shift reports; and
output a score indicating suitability of shift report data corresponding to the input text data, tabular data, image data, audio data or video data, for inclusion within a shift handover report;
wherein the processor implemented decision engine includes one or more processor implemented classifiers that have been configured based on historical data representing prior selection of shift report data for inclusion within shift handover report(s);
generating, and storing within the central shift report repository, a shift handover report comprising the selected set of shift report data; and
displaying within a user interface rendered on a display, the generated shift handover report comprising the selected set of shift report data.

2. The method as claimed in claim 1, wherein the one or more processor implemented classifiers includes at least a first text classifier configured to classify text data from one or more operator shift reports based on a plurality of text data categories, and wherein said text data comprises any one or more of log description data, log notes description data, log custom data, work instruction data, work instruction notes description data, work instruction custom data, shift handover incoming comment data, shift handover outgoing comment data, shift handover notes description data, shift handover process envelope data comments and shift handover custom data.

3. The method as claimed in claim 2, wherein the first text classifier is configured for classification of text data by implementing:
a first text classifier configuration step comprising adjusting one or more node weights associated with the first text classifier based on training data obtained from a public dataset;
a second text classifier configuration step comprising adjusting one or more node weights associated with the first text classifier based on vendor specific training data; and
a third text classifier configuration step comprising adjusting one or more node weights associated with the first text classifier based on plant specific training data associated with an industrial plant within which the shift handover report is being generated.

4. The method as claimed in claim 2, wherein the one or more processor implemented classifiers includes a second deep learning neural network configured for classification of image data, audio data or video data, and wherein the second deep learning neural network text classifier is configured by implementing:
a first deep learning neural network configuration step comprising adjusting one or more node weights associated with the second deep learning neural network based on vendor specific training data; and
a second deep learning neural network configuration step comprising adjusting one or more node weights associated with the second deep learning neural network based on plant specific training data associated with the industrial plant within which the shift handover report is being generated.

5. The method as claimed in claim 4, wherein the one or more processor implemented classifiers includes a third Naive Bayes classifier configured for classification of tabular data, wherein:
the third Naive Bayes classifier is implemented for classification of tabular data extracted from any of operations management log data, work instruction data, shift handover data, permit to work data, management of change data, and incident management data;
and wherein the third Naive Bayes classifier is configured by adjusting one or more node weights associated with the third Naive Bayes classifier based on plant specific training data associated with the industrial plant within which the shift handover report is being generated.

6. The method as claimed in claim 5, wherein the one or more processor implemented classifiers includes a fourth decision tree classifier configured for classification of tabular data, wherein:
the fourth decision tree classifier is implemented for classification of tabular data extracted from any of operations management log data, work instruction data, shift handover data, permit to work data, management of change data, and incident management data;
and wherein the fourth decision tree classifier is configured by adjusting one or more node weights associated with the fourth decision tree classifier based on plant specific training data associated with the industrial plant within which the shift handover report is being generated.

7. The method as claimed in claim 6, wherein the first text classifier, the second deep learning neural network, the third Naive Bayes classifier and the fourth decision tree classifier are implemented within a processor implemented ensemble model classifier.

8. The method as claimed in claim 1, wherein the selection of the set of shift report data is additionally based on one or more of:
selection of shift report data from the plurality of operator shift reports based on one or more rules for shift report data selection; and
selection of shift report data from the plurality of operator shift reports based on manual selection inputs received through the user interface.

9. The method as claimed in claim 1, wherein the user interface includes a processor implemented user interface comprising a display interface, wherein said display interface links one or more data records within the selected set of shift report data displayed within the generated shift handover report to a corresponding processor implementable data record viewer or editor, such that selecting a linked data record within the user interface triggers execution of the corresponding processor implementable data record viewer or editor.

10. The method as claimed in claim 9, wherein the processor implementable data record viewer or editor is displayed as a sub-window within a window of the display interface simultaneously with at least one other window within which the one or more data records within the selected set of shift report data is displayed.

11. A system for generating a shift handover report for display, the system comprising:
at least one memory
a central shift report repository; and
a processor implemented server communicatively coupled with the memory and the central shift report repository, and configured to:
receive a plurality of operator shift reports wherein each operator shift report:
includes shift report data corresponding to one or more shift events recorded during a shift assigned to a shift operator; and
is received from a client terminal communicatively coupled with the central shift report repository;
parse data extracted from each of the received plurality of operator shift reports, and select a set of shift report data from the parsed data, wherein selection of the set of shift report data is based on:
text data, tabular data, image data, audio data or video data, extracted from the parsed data; and
output received from a processor implemented decision engine that is configured to:
receive as input, one or more of text data, tabular data, image data, audio data or video data, parsed from one or more operator shift reports; and
output a score indicating suitability of shift report data corresponding to the input text data, tabular data, image data, audio data or video data, for inclusion within a shift handover report;
wherein the processor implemented decision engine includes one or more processor implemented classifiers that have been configured based on historical data representing prior selection of shift report data for inclusion within shift handover report(s);
generate, and store within the central shift report repository, a shift handover report comprising the selected set of shift report data; and
display within a user interface rendered on a display, the generated shift handover report comprising the selected set of shift report data.

12. The system as claimed in claim 11, wherein the one or more processor implemented classifiers includes at least a first text classifier configured to classify text data from one or more operator shift reports based on a plurality of text data categories, and wherein said text data comprises any one or more of log description data, log notes description data, log custom data, work instruction data, work instruction notes description data, work instruction custom data, shift handover incoming comment data, shift handover outgoing comment data, shift handover notes description data, shift handover process envelope data comments and shift handover custom data.

13. The system as claimed in claim 12, wherein the first text classifier is configured for classification of text data by implementing:
a first text classifier configuration step comprising adjusting one or more node weights associated with the first text classifier based on training data obtained from a public dataset;
a second text classifier configuration step comprising adjusting one or more node weights associated with the first text classifier based on vendor specific training data; and
a third text classifier configuration step comprising adjusting one or more node weights associated with the first text classifier based on plant specific training data associated with an industrial plant within which the shift handover report is being generated.

14. The system as claimed in claim 12, wherein the one or more processor implemented classifiers includes a second deep learning neural network configured for classification of image data, audio data or video data, and wherein the second deep learning neural network text classifier is configured by implementing:
a first deep learning neural network configuration step comprising adjusting one or more node weights associated with the second deep learning neural network based on vendor specific training data; and
a second deep learning neural network configuration step comprising adjusting one or more node weights associated with the second deep learning neural network based on plant specific training data associated with the industrial plant within which the shift handover report is being generated.

15. The system as claimed in claim 14, wherein the one or more processor implemented classifiers includes a third Naive Bayes classifier configured for classification of tabular data, wherein:
the third Naive Bayes classifier is implemented for classification of tabular data extracted from any of operations management log data, work instruction data, shift handover data, permit to work data, management of change data, and incident management data;
and wherein the third Naive Bayes classifier is configured by adjusting one or more node weights associated with the third Naive Bayes classifier based on plant specific training data associated with the industrial plant within which the shift handover report is being generated.

16. The system as claimed in claim 15, wherein the one or more processor implemented classifiers includes a fourth decision tree classifier configured for classification of tabular data, wherein:
the fourth decision tree classifier is implemented for classification of tabular data extracted from any of operations management log data, work instruction data, shift handover data, permit to work data, management of change data, and incident management data;
and wherein the fourth decision tree classifier is configured by adjusting one or more node weights associated with the fourth decision tree classifier based on plant specific training data associated with the industrial plant within which the shift handover report is being generated.

17. The system as claimed in claim 16, wherein the first text classifier, the second deep learning neural network, the third Naive Bayes classifier and the fourth decision tree classifier are implemented within a processor implemented ensemble model classifier.

18. The system as claimed in claim 11, wherein the selection of the set of shift report data is additionally based on one or more of:
selection of shift report data from the plurality of operator shift reports based on one or more rules for shift report data selection; and
selection of shift report data from the plurality of operator shift reports based on manual selection inputs received through the user interface.

19. The system as claimed in claim 11, wherein the user interface includes a processor implemented user interface comprising a display interface, wherein said display interface links one or more data records within the selected set of shift report data displayed within the generated shift handover report to a corresponding processor implementable data record viewer or editor, such that selecting a linked data record within the user interface triggers execution of the corresponding processor implementable data record viewer or editor.

20. The system as claimed in claim 19, wherein the processor implementable data record viewer or editor is displayed as a sub-window within a window of the display interface simultaneously with at least one other window within which the one or more data records within the selected set of shift report data is displayed.

21. A computer program product for optimizing generating a shift handover report for display, the computer program product comprising a non-transitory computer usable medium having a computer readable program code embodied therein, the computer readable program code comprising instructions for implementing within a processor based computing system, the steps of:
receiving at a central shift report repository, a plurality of operator shift reports wherein each operator shift report:
includes shift report data corresponding to one or more shift events recorded during a shift assigned to a shift operator; and
is received from a client terminal communicatively coupled with the central shift report repository;
parsing data extracted from each of the received plurality of operator shift reports, and selecting a set of shift report data from the parsed data, wherein selection of the set of shift report data is based on:
text data, tabular data, image data, audio data or video data, extracted from the parsed data; and
output received from a processor implemented decision engine that is configured to:
receive as input, one or more of text data, tabular data, image data, audio data or video data, parsed from one or more operator shift reports; and
output a score indicating suitability of shift report data corresponding to the input text data, tabular data, image data, audio data or video data, for inclusion within a shift handover report;
wherein the processor implemented decision engine includes one or more processor implemented classifiers that have been configured based on historical data representing prior selection of shift report data for inclusion within shift handover report(s);
generating, and storing within the central shift report repository, a shift handover report comprising the selected set of shift report data; and
displaying within a user interface rendered on a display, the generated shift handover report comprising the selected set of shift report data.
